(19) United States
(12) Patent Application Publication
(10) Pub. No.: US 2007/0040924 A1
(43) Pub. Date: Feb. 22, 2007

(54) Cellular phone camera with three-dimensional imaging function

(75) Inventors: Gyoung Il Cho, Seoul (KR); Cheong Soo Seo, Seongnam (KR)

Correspondence Address: STEREO DISPLAY INC., 980 EAST ORANGETHORPE AVENUE, SUITE F, ANAHEIM, CA, 92801, US

(73) Assignees: Stereo Display, Inc., Anaheim, CA (US); Angstrom, Inc., Suwon (KR)

(21) Appl. No.: 11/208,115

(22) Filed: Aug. 19, 2005

(51) Int. Cl. H04N 5/232; G03B 13/00; H04N 5/225; G02B 13/16

(52) U.S. Cl. 348/335; 348/345

(57) ABSTRACT

This real-time three-dimensional imaging system for a cellular phone camera generates an all-in-focus image with depth information. The system comprises a micromirror array lens, an imaging unit for capturing images with different focal planes, which are changed by the micromirror array lens, an image processing unit for processing the images taken by the imaging unit and converting the processed images into three-dimensional displayable type, and three-dimensional display unit for displaying the processed three-dimensional images. “Depth from focus” method is used to get an all-in-focus image and depth information from multiple two-dimensional images with different focal planes. This system is compact because only one camera system is used for three-dimensional imaging. For the real-time three-dimensional imaging, micromirror array lens with high-speed variable focus and high speed image processing unit are used. This application has also real-time auto focusing and optical zooming function.

### BACKGROUND OF THE INVENTION

The present invention is related with a cellular phone camera with three-dimensional imaging function using a micromirror array lens.

There are many three-dimensional imaging devices proposed and developed. Most common three-dimensional imaging method illustrated in FIG. 1 is having two images from two different cameras with a fixed optical angle to encode the depth information of the three-dimensional image as well as the image itself. Embodiment of this method needs to have two cameras. Owing to the small size of cellular phone, embedding two cameras in a pocket-sized cellular phone is hard to devise. Compact camera system and three-dimensional imaging method using one camera is strongly preferred to devise the three-dimensional imaging device for a cellular phone.

Other method with one camera was developed using “depth from focus” criterion and fast response variable focal length lens which can be found in T. Kaneko et al., 2000, “Quick Response Dynamic Focusing Lens using Multi-Layered Piezoelectric Bimorph Actuator”, Proceeding of SPIE Vol. 4075: 24-31. In this system, a variable focal length lens comprised of two thin glass diaphragms and transparent working fluid of high refractive index inside. Multi-layered piezoelectric bimorph actuator adjusts the shape of the diaphragms for varying the focal length of the lens. “Depth from focus” method achieves an all-in-focus image and depth information from multiple two-dimensional images with different focal planes. Since the variable focal length lens has a slow time response (150 Hz), it cannot accomplish real-time three-dimensional image. Also in a dimension of the size, multi-layered piezoelectric actuator type has too large a size (14 mm×14 mm×16 mm) to fit into the pocket-sized applications like cellular phones. The lens has a small focal plane variation in the range of a few millimeters, which limits the possible range of depth and the depth resolution of the three-dimensional image. To get a good quality three-dimensional image, a high speed, compact variable focal length lens with large focal length variation should be introduced.

Three-dimensional imaging device with a high quality and real-time image in a cellular phone needs an imaging system performed with compact device and a high speed, compact variable focal length lens with large focal length variation.

### SUMMARY OF THE INVENTION

The objective of the present invention is to provide a real-time three-dimensional imaging system for a cellular phone camera and to solve the difficulties for embedding three-dimensional imaging function in a pocket-sized cellular phone by use of variable focal micromirror array lens.

The real-time three-dimensional imaging system for a cellular phone camera generates an all-in-focus image with depth information. The system comprises a variable focal length lens, an imaging unit for capturing images with different focal planes, which are changed by the variable focal length lens, an image processing unit for processing the images taken by the imaging unit and converting the processed images to three-dimensional displayable type, and three-dimensional display unit for displaying the processed three-dimensional images.

The variable focal length lens comprises a micromirror array lens. The focal plane of the imaging device is changed by varying the focal length of the micromirror array lens as described in U.S. patent application Ser. No. 10/855,287 for “Variable focusing lens comprising micromirrors with two degrees of freedom rotation and one degree of freedom translation” filed on May 27, 2004, Ser. No. 10/857,280 for “Variable focusing lens comprising micromirrors with one degree of freedom translation” filed on May 28, 2004, and Ser. No. 10/983,353 for “Variable focal length lens comprising micromirrors” filed on Nov. 8, 2004.

The variable focal length lens also performs auto-focusing and zooming function of the camera as described in U.S. patent application Ser. No. 10/896,141 for “High Speed Automatic Focusing System” filed on Jul. 21, 2004 and U.S. patent application Ser. No. 10/806,299 for “Small and Fast Zoom System” filed on Mar. 22, 2004. Zooming function devised by the micromirror array lens is compact and does not have macroscopic mechanical motions of lenses. Since the zoom system with the micromirror array lens has no macroscopic mechanical motions of lenses, the system consumes minimal power to perform the function. Another advantage of the invention is to provide a zoom system that can compensate various optical distortions or aberrations.

The imaging unit includes one or more two-dimensional image sensors taking two-dimensional images at different focal planes.

The image processing unit generates the all-in-focus image with depth information from the two dimensional images taken by the imaging unit and converts the all-in-focus image into three-dimensional displayable data format. It is desirable that all the processes are achieved within a unit time which is less than or equal to the afterimage time of the human eyes.

The three-dimensional display unit displays the three-dimensional images and all-in-focus images processed by the image processing unit. The display unit also displays the two-dimensional images taken from the imaging unit. For three-dimensional display, lenticular three-display method or other three-display method can also be used.

The micromirror array lens includes a plurality of micromirrors. The translation and/or rotation of each micromirror of the micromirror array lens are controlled to vary the focal length of the variable focal length lens.

The micromirrors of the micromirror array lens are arranged to form one or more concentric circles.

Each micromirror of the micromirror array lens may have a fan shape to enhance the optical efficiency.

The reflective surface of each micromirror of the micromirror array lens is substantially flat. Alternatively, the reflective surface of each micromirror of the micromirror array lens can have a curvature. The curvature of the micromirrors can be controlled.

Preferably, the reflective surface of the micromirror is made of metal.

Each micromirror of the micromirror array lens is actuated by the electrostatic force and/or electromagnetic force.

The micromirror array lens further includes a plurality of mechanical structures upholding the micromirrors and actuating components for rotating and translating the micromirrors. The mechanical structures and the actuating components are located under the micromirrors for maximize the reflecting surface area to enhance the optical efficiency.

The micromirror array lens is a reflective Fresnel lens, and the micromirrors are arranged in a flat plane. Each micromirror has the same function as a mirror. The array of micromirrors works as a reflective focusing lens by making all light scattered from an object converge into a focal plane and meet periodic phase condition among the lights from different micromirrors. In order to perform this procedure, the micromirrors are electrostatically and/or electromagnetically controlled by actuating components to have desired positions. The focal length of the lens is changed by controlling translation of micromirrors, by controlling rotation of micromirrors, or by controlling both translation and rotation of micromirrors.

The micromirror array lens is an adaptive optical component. The micromirror array lens compensates for phase errors of light introduced by the medium between an object and its image.

The three-dimensional imaging system includes a micromirror array lens and a image sensor. Micromirror array lens focuses the image onto a image sensor. Alternatively, a beam splitter can be used between the micromirror array lens and an image.

The micromirror array lens in three-dimensional imaging system is an adaptive optical component. The micromirror array lens compensates for phase errors of light introduced by the medium between an object and its image and/or corrects the defects of the three-dimensional imaging. Also, an object which does not lie on the optical axis can be imaged by the micromirror array lens without any macroscopic mechanical movement of the three-dimensional imaging system.

In order to obtain a color image, the micromirror array lens is controlled to satisfy the same phase condition for each wavelength of Red, Green, and Blue (RGB), respectively. The three-dimensional imaging system may further include a plurality of bandpass filters, photoelectric sensor for color imaging. Photoelectric sensor includes Red, Green, and Blue (RGB) sensors.

A color image is obtained by processing electrical signals from the Red, Green, and Blue (RGB) sensors according to an image processing method. The processing of electric signals from the Red, Green, and Blue (RGB) sensors is synchronized and/or matched with the control of the micromirror array lens to satisfy the same phase condition for each wavelength of Red, Green, and Green (RGB), respectively.

The micromirror array lens includes micromirrors and actuating components, and uses a very simple mechanism to control the focal length. The focal length of the micromirror array lens can be changed by translation and/or rotation of each micromirror.

Since micromirror has a tiny mass, the lens comprising micromirrors has a very fast response time down to hundreds of microseconds. The lens also has a large focal length variation and a high optical focusing efficiency. In addition, the lens design makes a large size lens possible, makes the focusing system very simple, and requires low power consumption. The lens has a low production cost because of the advantage of mass productivity.

The micromirror array lens can compensate for optical effects introduced by the medium between the object and its image and/or corrects the defects of a lens system.

The micromirror array lens can have a polar array of micromirrors. For the polar array, each micromirror has a fan shape to increase the optical efficiency by expanding active reflecting region. The aberration of the micromirror array lens can be reduced by micromirrors with curvatures. The optical efficiency of the micromirror array lens can be increased by locating a mechanical structure upholding the micromirror and the actuating components under the micromirror to enhance the optical efficiency by increasing the active area of reflecting surface. Electric circuits to operate the micromirrors can be replaces with know semiconductor technologies such as MOS and CMOS.

The micromirror array lens used in present invention has the following advantages: (1) the micromirror array lens has a very fast response time thanks to the tiny mass of the micromirror; (2) the lens has compactness in size suitable for a cellular phone applications; (3) the lens has a large focal length variation because large numerical aperture variations can be achieved by increasing the maximum rotational angle of the micromirror; (4) the lens has a high optical efficiency; (5) the lens can have a large size aperture without losing optical performance. Since the micromirror array lens includes discrete geometry comprising micromirrors, the increase of the lens size does not enlarge the aberration caused by the shape error of a lens; (6) the cost is inexpensive because of the advantage of mass productivity of microelectronics manufacturing technology; (7) the lens can compensate for phase errors introduced by the medium between the object and the image and/or corrects the defects of the lens system; (8) the lens makes the focusing system much simpler; (9) the lens requires small power consumption when electrostatic actuation is used to control it.

The invention of cellular phone camera with three-dimensional imaging function has the following advantages: (1) the device can make a real-time three-dimensional image (2) the device has an auto-focusing function; (3) the device has an optical zooming function without any macroscopic mechanical movement; (4) the device can capture real-time all-in-focus image; (5) the device can process and covert image into three-dimensional displayable format; (6) the device can convert two-dimensional images into lenticular type three-dimensional display or other three-dimensional displayable formats; (7) the device has a large range of depth; (8) the device can have high depth resolution; (9) the cost is inexpensive because the micromirror array lens is inexpensive; (10) the device has a high optical efficiency; (11) the device can compensate for phase errors introduced by the medium between the object and its image and/or correct the defects of a lens system; (12) the device is very simple because there is no macroscopic mechanical displacement or deformation of the lens; (13) the device is compact; (14) the device requires small power consumption when the micromirror array lens is actuated by electrostatic force.

Although the present invention is brief summarized herein, the full understanding of the invention can be obtained by the following drawings, detailed description, and appended claims.

### BRIEF DESCRIPTION OF THE DRAWINGS

These and other features, aspects, and advantages of the present invention will become better understood with reference to the accompanying drawings, wherein:

FIG. 1 is a schematic diagram showing the cellular phone camera with three-dimensional imaging function by the conventional method.

FIG. 2 is a schematic diagram showing the cellular phone camera with three-dimensional imaging function using a micromirror array lens.

FIG. 3 is a schematic diagram showing how a three-dimensional image is obtained from two-dimensional images with different focal planes changing the focal length of micromirror array lens.

FIG. 4 is a schematic diagram showing three-dimensional imaging function device in a cellular phone camera using the micromirror array lens.

FIG. 5 is a schematic diagram showing three-dimensional imaging function device in a cellular phone camera using a beam splitter and the micromirror array lens.

FIG. 6 shows the principle of the micromirror array lens.

FIG. 7 is a schematic plane view showing the structure of the lens that is made of many micromirrors and actuating components.

FIG. 8 is a schematic diagram showing how a micromirror array lens works as a lens.

FIG. 9 is a schematic diagram showing the three-dimensional imaging device using an auxiliary lens.

### DETAILED DESCRIPTION

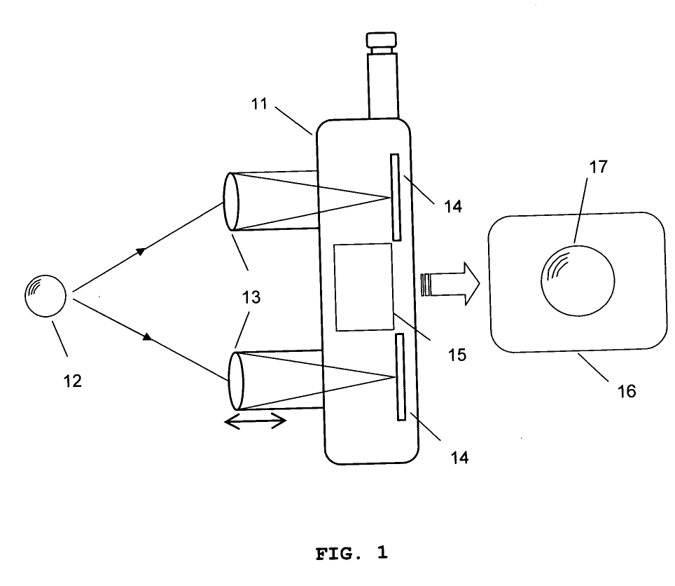

FIG. 1 shows a schematic diagram of present three-dimensional imaging function in a cellular phone 11. From the object 12, two lenses 13 focus the images onto the imaging sensors 14. The captured images are processed by the image processing unit 15 to display the three-dimensional image 17 in the display unit 16 if the system is attached with displaying device. For the purpose of three-dimensional imaging, two lenses and two imaging sensors are necessary. Since this scheme uses two lenses, two imaging sensors altogether, the embodiment of the three-dimensional imaging function in a cellular phone 11 is quite large, complicated and hard to be accomplished.

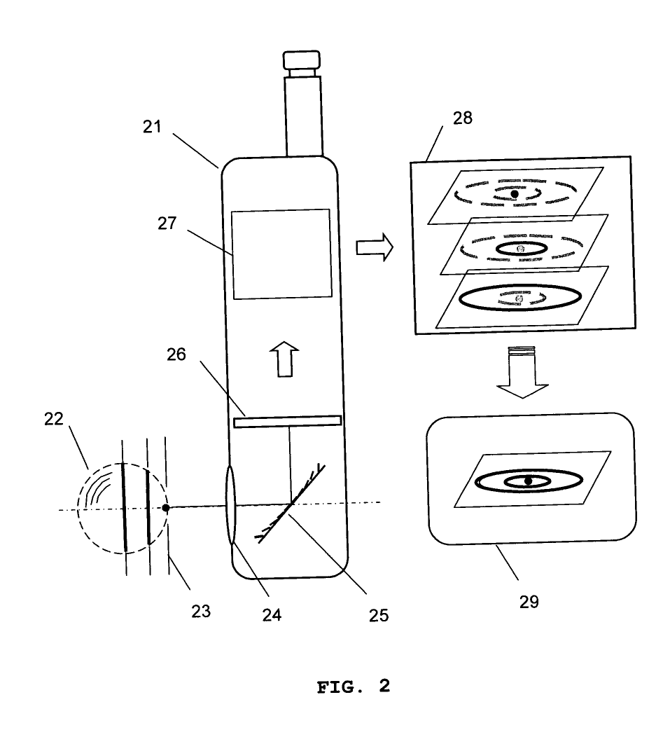

FIG. 2 shows a schematic diagram for the present invention, cellular phone camera 21 with three-dimensional function accomplished by the variable focus micromirror array lens. Only one imaging sensor 26 is installed in the cellular phone 21 to get a three-dimensional image from the object 22. From the object 22, two-dimensional images 28 are captured by varying the focal plane 23 by changing the focal length of the micromirror lens 25. The auxiliary lens 24 enhances the focusing ability of the micromirror lens 25. After getting the two-dimensional images varying the focal planes, the image processing unit 27 performs extracting the all-in-focus image 29 from the captured images and delivers the processed data to the display unit. Also the image processing unit can convert the data format into other displayable image format and display unit shows the three-dimensional images.

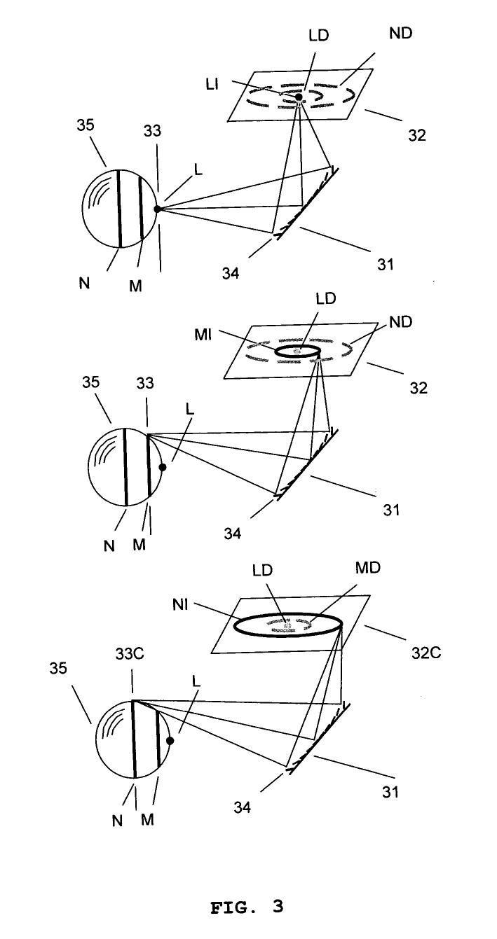

FIG. 3 shows how a micromirror array lens 31 takes two-dimensional images 32A, 32B, 32C with the focal planes 33A, 33B, 33C changing the focal length of the micromirror array lens 31. The micromirror array lens 31 includes many micromirrors 34. The focal length of the micromirror array lens 31 is changed by rotation and translation of each micromirror 34 by electrostatic and/or electromagnetic force. Two-dimensional images 32A, 32B, 32C are taken with the depth information which corresponds to the position of the focal plane. The two-dimensional image 32A has in-focus image LI at the focal plane 33A, which is the image of the portion L of an object 35. Images MD, ND of portion M, N of an object 35 are defocused. The image processing unit determines the in-focus pixels LI from the two-dimensional images 32A. The first two-dimensional image 32A gives in-focus pixels LI with the depth information of the focal plane 33A. The two-dimensional images 32B, 32C with the second and third focal plane 33B, 33C are processed in the same manner as the first focal plane to get in-focus images with depth information.

FIG. 4 shows a three-dimensional imaging device 41. The imaging device takes an all-in-focus image 46 and depth information of the image from the two-dimensional images varying the focal planes. The device includes a variable focal length lens 42, an imaging unit 43 capturing images 45, and an image processing unit 44 processing the images 45.

The focal plane of the imaging device is changed by change of focal length of the micromirror array lens 42.

The imaging unit 43 includes one or more two-dimensional image sensor taking original two-dimensional images 45 with different focal planes.

The image processing unit 44 generates the all-in-focus image 46 and the depth information for in-focus image from two-dimensional images. All the processes are achieved within a unit time which is less than or equal to the afterimage time of the human eye.

While the micromirror array lens 42 varies the focal length of the micromirror array lens, the image sensor 43 takes two-dimensional images 45 with corresponding optical depth information. The desired number of depths is determined by the depth resolution and the range of depth of the object to be imaged. To get real-time three-dimensional motion images, two-dimensional images should be taken and processed within the afterimage time of human eyes. There are several methods for the image processing to obtain all-in-focus image 46 and depth information for each pixel of the image. After having the all-in-focus image, the image data can be converted into various three-dimensional displayable image formats.

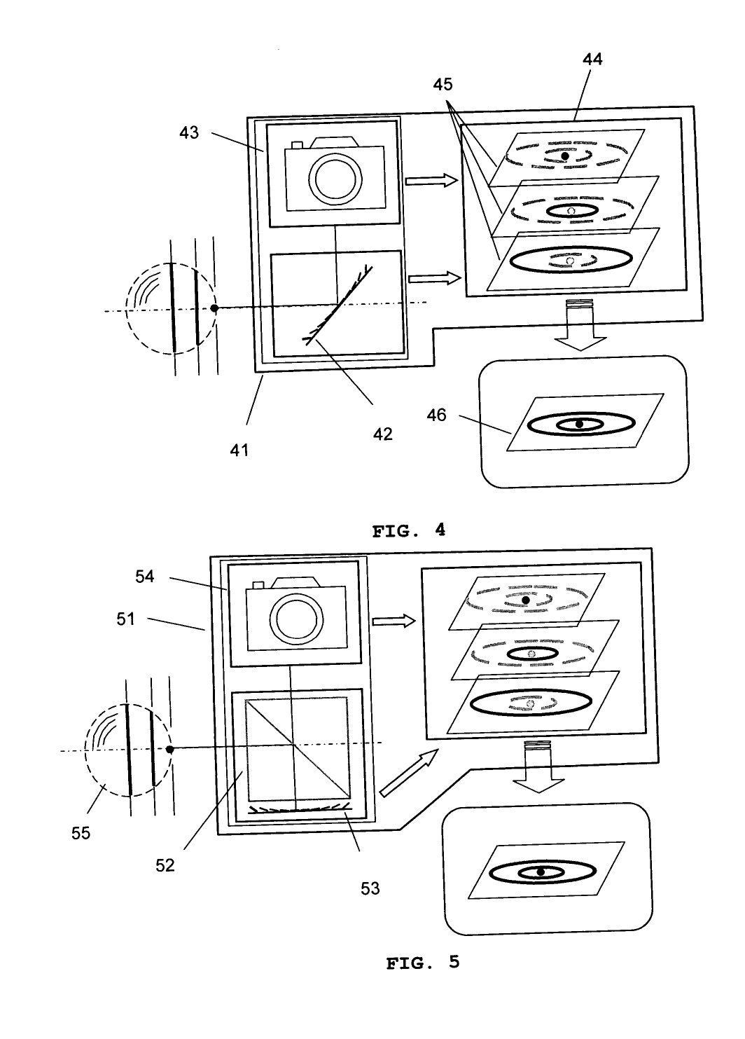

FIG. 5 shows an alternative arrangement in which the three-dimensional imaging device 51 further includes a beam splitter 52 positioned in the path of light between the micromirror array lens 53 and the image sensor 54. To have a head-on reflection from the micromirror array lens, an extra optics is necessary. A beam splitter 52 is located in the beam path to change the light direction to the micromirror array lens 53 and send focused image to the image sensor 54 through the beam splitter. As shown in FIG. 4, the alternative setup for the micromirror array lens 42 is possible. Micromirror array lens can be located so that the reflected light by the micromirror array lens 42 is directly delivered to the image sensor without using a beam splitter.

FIG. 6 shows the principle of a micromirror array lens 61. Two conditions should be satisfied to build a perfect lens. One is a converging condition that all light scattered by one point of an object should converge into one point of the image plane. The other is the same phase condition that all the converging light at the image plane should have the same phase. To satisfy the perfect lens conditions, the surface shape of conventional reflective lens 62 reflects all the incident light scattered from one point of an object to one point on the image plane with the same optical path length traveled. Thanks to the periodicity of the light phase, the same phase condition can be satisfied even though the optical path length of the converging light is different. When the difference of the optical path length is exactly the same with the multiples of wavelength, the reflected beam at the focus meets the phase condition. Therefore, the surface shape of the conventional reflective lens 62 satisfying perfect lens conditions can be replaced by rotation and translation of micromirrors. Each micromirror 63 rotates to converge into focal point and translates to adjust the phase between the reflected lights from different micromirrors 63.

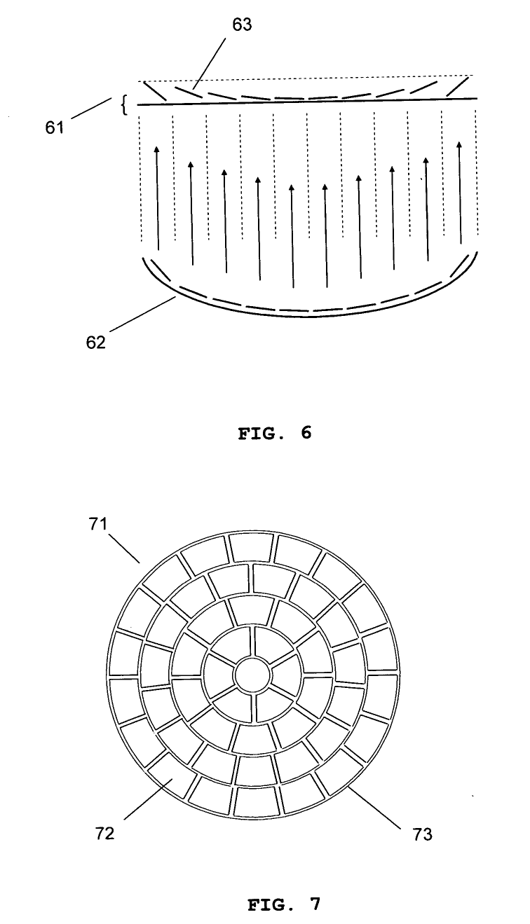

FIG. 7 illustrates the two-dimensional view of a micromirror array lens 71. Each micromirror 72 of the micromirror array lens 71 is controlled by electrostatic and/or electromagnetic force made by actuating components 73. Because a lens is axis-symmetric, the micromirror array lens 71 can have a polar array of the micromirrors 72. Each of the micromirrors 72 can have a fan shape to maximize the effective reflecting area and increase the optical efficiency.

The mechanical structures upholding each micromirror and the actuating components to rotate and translate the micromirrors 72 are located under the micromirrors 72 so that the micromirrors 72 have larger active area.

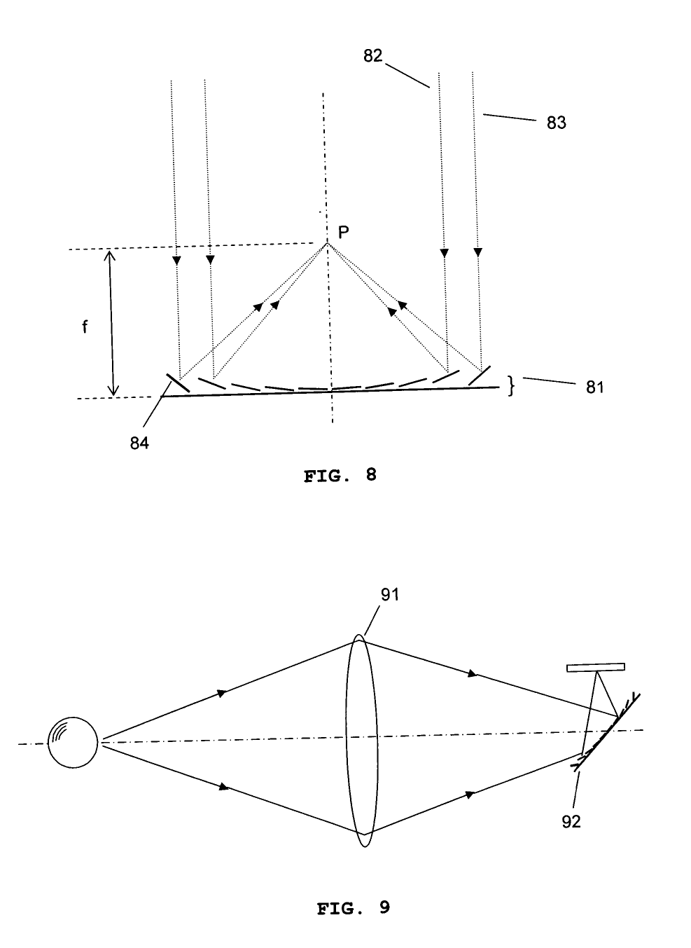

FIG. 8 illustrates how the micromirror array lens 81 makes an image. Arbitrary scattered lights 82, 83 from the object are converged into one point P on the image plane by controlling the position of each of the micromirrors 84. Phases of individual lights 82, 83 can be adjusted to have the same value by translating each of the micromirrors 84. The required translational displacement is at least half of the wavelength of light.

The focal length f of the micromirror array lens 81 is adjustable by controlling the rotation and/or translation of the micromirror 84. The operation of the micromirror array lens 81 is possible by controlling only rotation regardless of the phase condition. In this case, the quality of the image generated by the micromirror array lens is degraded by the aberration. Also translation only without rotation can form a Fresnel diffraction lens with the aberration. The smaller the sizes of the micromirrors 84 can reduce the aberration. Even though the focusing ability of the one motion by either rotation or translation is not powerful, the lens with one motion has the advantage of simple control and fabrication.

Since the ideal shape of the conventional lens 62 has a curvature even in the small size of the micromirror, it is strongly desired that each of the micromirrors 84 has a curvature itself. However, since the aberration of the lens with flat micromirrors 84 is not much different from the lens with curvature if the size of each micromirror is small enough, there is not much need to control the curvature.

FIG. 9 shows that an effective focal length and numerical aperture of the micromirror array lens 92 combined with an auxiliary lens 91 or lenses can have extended numerical aperture and effective focal length.

The micromirror array lens is an adaptive optical component with the phase of light compensated by the translations and/or rotations of micromirrors. The micromirror array lens can correct the phase errors of light introduced by the medium between the object and its image and/or corrects the defects of a lens system.

The phase matching condition implicits that the light used should be monochromatic. To get a color image, the micromirror array lens in cellular phone camera with three-dimensional imaging function, the same phase condition for each wavelength of Red, Green, and Blue (RGB), should be satisfied respectively, and the system can use bandpass filters to make monochromatic lights at the wavelength of Red, Green, and Blue (RGB).

If a color photoelectric sensor is used as an image sensor in cellular phone camera with three-dimensional imaging function using a micromirror array lens, a color image can be obtained by processing electrical signals from Red, Green, and Blue (RGB) sensors with or without bandpass filters, which should be synchronized with the control of micromirror array lens.

The cellular phone camera with three-dimensional imaging function can have the optical zooming function by the focal length variation of the micromirror array lens without any macroscopic mechanical movement. The variable focal length lens also performs auto-focusing and zooming function of the camera.

Zooming function devised by the variable focus lens of the micromirror array lens is compact and does not have macroscopic mechanical motions of lenses. Since the zoom system with the micromirror array lens has no macroscopic mechanical motions of lenses, the system consumes minimal power to perform the function. Another advantage of the invention is to provide a zoom system that can compensate various optical distortions or aberrations.

The fast response of the micromirror enables the auto-focusing function if applied with the focus finding algorithm in image processing unit. Image processing unit processes the taken two-dimensional image to determine whether the object image lies on the focus or not. If the focus and object image lies in different planes, the active feedback can track for finding appropriate focus by varying the focal lens of the micromirror array lens. Since the response of the micromirror array lens is very fast, the auto focusing function can perform the process within very short time scale.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A cellular phone camera with three-dimensional imaging function comprising:
(a) a micromirror array lens with variable focal length;
(b) an imaging unit on which an image of the objects at a given focal length of the micromirror array lens is formed;
(c) an image processing unit generating the all-in-focus image with depth information from the two-dimensional images taken by the imaging unit

2. The cellular phone camera of claim 1, wherein the cellular phone camera is embodied in the cellular phone with three-dimensional display unit displaying the three-dimensional images from the image processing unit

3. The cellular phone camera of claim 1, wherein the focal plane for taking the three-dimensional images is changed by varying of focal length of the micromirror array lens.

4. The cellular phone camera of claim 1, wherein the imaging unit comprises one or more two-dimensional image sensors taking the two-dimensional images at each focal plane.

5. The cellular phone camera of claim 1, wherein the imaging unit has a function of auto-focusing by changing the focal length of the micromirror array lens.

6. The cellular phone camera of claim 1, wherein the imaging unit has a function of optical zooming by varying the focal length of the micromirror array lens.

7. The cellular phone camera of claim 1, wherein the image processing unit generates all-in-focus image and depth information from the two-dimensional images.

8. The cellular phone camera of claim 7, wherein the processing unit converts the all-in-focus image and depth information into the three dimensional displayable format.

9. The cellular phone camera of claim 2, wherein the three-dimensional display unit displays all-in-focus images from the processing unit.

10. The cellular phone camera of claim 1, wherein further comprising a beam splitter positioned in the path of light between the imaging unit and the micromirror array lens.

11. The cellular phone camera of claim 1, wherein the micromirror array lens is positioned with tilt about optical axis.

12. The cellular phone camera of claim 1, wherein further comprising one or more auxiliary lenses having a predetermined focal length, and wherein the effective focal length of the imaging system is determined by the micromirror array lens and the auxiliary lens together.

13. The cellular phone camera of claim 1, wherein further comprising one or more auxiliary lenses having a predetermined focal length, and wherein the numerical aperture of the imaging system is increased by the auxiliary lens.

14. The cellular phone camera of claim 1, wherein the cellular phone camera has a zooming function.
